(19) United States
(12) Patent Application Publication
(10) Pub. No.: US 2014/0354898 A1
(43) Pub. Date: Dec. 4, 2014

(54) DISPLAY WITH PIXEL-OBSCURING MICRO-WIRES

(71) Applicant: Ronald Steven Cok, Rochester, NY (US)

(72) Inventor: Ronald Steven Cok, Rochester, NY (US)

(21) Appl. No.: 13/906,643

(22) Filed: May 31, 2013

(51) Int. Cl. G06F 1/16

(52) U.S. Cl. CPC G06F 1/1643
USPC 349/12

(57) ABSTRACT

A display device with micro-wires includes a display having an arrangement of pixels. Substantially opaque micro-wires are arranged over the pixels so that the micro-wires occlude substantially equal amounts of light from each pixel.

### CROSS REFERENCE TO RELATED APPLICATIONS

Reference is made to commonly assigned, co-pending U.S. patent application Ser. No. ______ filed concurrently herewith, entitled “Display Apparatus With Pixel-Obscuring Micro-Wires” by Ronald S. Cok; commonly assigned, co-pending U.S. patent application Ser. No. ______ filed concurrently herewith, entitled “Making Display Device With Pixel-Obscuring Micro-Wires” by Ronald S. Cok; U.S. patent application Ser. No. 13/587,152 filed Aug. 16, 2012, entitled “Pixel-Aligned Micro-Wire Electrode Device” by Ronald S. Cok; and U.S. patent application Ser. No. 13/591,283 filed Aug. 22, 2012, entitled “Pixel-Aligned Diamond-Patterned Micro-Wire Electrode” by Ronald S. Cok, the disclosures of which are incorporated herein.

### FIELD OF THE INVENTION

The present invention relates to micro-wire electrodes incorporated into capacitive touch-screens in association with displays.

### BACKGROUND OF THE INVENTION

Transparent conductors are widely used in the flat-panel display industry to form electrodes that are used to electrically switch light-emitting or light-transmitting properties of a display pixel, for example in liquid crystal or organic light-emitting diode displays. Transparent conductive electrodes are also used in touch screens in conjunction with displays. In such applications, the transparency and conductivity of the transparent electrodes are important attributes so that they do not inhibit the visibility or appearance of the displays. In general, it is desired that transparent conductors have a high transparency (for example, greater than 90% in the visible spectrum) and a low electrical resistivity (for example, less than 10 ohms/square).

Touch screens with transparent electrodes are widely used with electronic displays, especially for mobile electronic devices. Such devices typically include a touch screen mounted over an electronic display that displays interactive information. Touch screens mounted over a display device are largely transparent so a user can view displayed information through the touch-screen and readily locate a point on the touch-screen to touch and thereby indicate the information relevant to the touch. By physically touching, or nearly touching, the touch screen in a location associated with particular information, a user can indicate an interest, selection, or desired manipulation of the associated particular information. The touch screen detects the touch and then electronically interacts with a processor to indicate the touch and touch location on the touch screen. The processor can then associate the touch and touch location with displayed information to execute a programmed task associated with the information. For example, graphic elements in a computer-driven graphic user interface are selected or manipulated with a touch screen mounted on a display that displays the graphic user interface.

Touch screens use a variety of technologies, including resistive, inductive, capacitive, acoustic, piezoelectric, and optical technologies. Such technologies and their application in combination with displays to provide interactive control of a processor and software program are well known in the art. Capacitive touch-screens are of at least two different types: self-capacitive and mutual-capacitive. Self-capacitive touch-screens employ an array of transparent electrodes, each of which in combination with a touching device (e.g. a finger or conductive stylus) forms a temporary capacitor whose capacitance is detected. Mutual-capacitive touch-screens can employ an array of transparent electrode pairs that form capacitors whose capacitance is affected by a conductive touching device. In either case, each capacitor in the array is tested to detect a touch and the physical location of the touch-detecting electrode in the touch-screen corresponds to the location of the touch. For example, U.S. Pat. No. 7,663,607 discloses a multipoint touch-screen having a transparent capacitive sensing medium configured to detect multiple touches or near touches that occur at the same time and at distinct locations in the plane of the touch panel and to produce distinct signals representative of the location of the touches on the plane of the touch panel for each of the multiple touches. The disclosure teaches both self- and mutual-capacitive touch-screens.

Since touch-screens are largely transparent so as not to inhibit the visibility or appearance of the displays over which the touch-screens are located, any electrically conductive materials located in the transparent portion of the touch-screen either employ transparent conductive materials or employ conductive elements that are too small to be readily resolved by the eye of a touch-screen user. Transparent conductive metal oxides are well known in the display and touch-screen industries and have a number of disadvantages, including limited transparency and conductivity and a tendency to crack under mechanical or environmental stress. This is particularly problematic for flexible touch-screen-and-display systems. Typical prior-art conductive electrode materials include conductive metal oxides such as indium tin oxide (ITO) or very thin layers of metal, for example silver or aluminum or metal alloys including silver or aluminum. These materials are coated, for example, by sputtering or vapor deposition, and are patterned on display or touch-screen substrates, such as glass. However, the current-carrying capacity of such electrodes is limited, thereby limiting the amount of power that can be supplied to the pixel elements. Moreover, the substrate materials are limited by the electrode material deposition process (e.g. sputtering). Thicker layers of metal oxides or metals increase conductivity but reduce the transparency of the electrodes.

Various methods of improving the conductivity of transparent conductors are taught in the prior art. For example, U.S. Pat. No. 6,812,637 describes an auxiliary electrode to improve the conductivity of the transparent electrode and enhance the current distribution. Such auxiliary electrodes are typically provided in areas that do not block light emission, e.g., as part of a black-matrix structure.

It is also known in the prior art to form conductive traces using nano-particles including, for example silver. The synthesis of such metallic nano-crystals is known. For example, U.S. Pat. No. 6,645,444 describes a process for forming metal nano-crystals optionally doped or alloyed with other metals. U.S. Patent Application Publication No. 2006/0057502 describes fine wirings made by drying a coated metal dispersion colloid into a metal-suspension film on a substrate, pattern-wise irradiating the metal-suspension film with a laser beam to aggregate metal nano-particles into larger conductive grains, removing non-irradiated metal nano-particles, and forming metallic wiring patterns from the conductive grains. However, such wires are not transparent and thus the number and size of the wires limits the substrate transparency as the overall conductivity of the wires increases.

Touch-screens including very fine patterns of conductive elements, such as metal micro-wires or conductive traces are known. For example, U.S. Patent Application Publication No. 2011/0007011 teaches a capacitive touch screen with a mesh electrode, as does U.S. Patent Application Publication No. 2010/0026664.

It is known that micro-wire electrodes in a touch-screen can visibly interact with pixels in a display and various layout designs are proposed to avoid such visible interaction. Furthermore, metal wires can reflect light, reducing the contrast of displays in which the metal wires are present. Thus, the pattern of micro-wires in a transparent electrode is important for optical as well as electrical reasons.

A variety of layout patterns are known for micro-wires used in transparent electrodes. U.S. Patent Application Publication 2010/0302201 teaches that a lack of optical alignment between the rows and columns of the underlying LCD pixels and the overlying diamond-shaped electrodes having edges arranged at 45-degree angles with respect to the underlying rectangular grid of LCD pixels results in a touch-screen largely free from the effects of Moiré patterns or other optical interference effects that might otherwise arise from light reflecting, scattering, refracting or otherwise interacting between the underlying pattern of LCD pixels and the overlying pattern of drive and sense electrodes in undesired or unexpected ways.

U.S. Patent Application Publication No. 2012/0031746 discloses a number of micro-wire electrode patterns, including regular and irregular arrangements. The conductive pattern of micro-wires in a touch screen can be formed by closed figures distributed continuously in an area of 30% or more, preferably 70% or more, and more preferably 90% or more of an overall area of the substrate and can have a shape where a ratio of standard deviation for an average value of areas of the closed figures (a ratio of area distribution) can be 2% or more. As a result, a Moiré phenomenon can be prevented and excellent electric conductivity and optical properties can be satisfied.

U.S. Patent Application Publication No. 2012/0162116 discloses a variety of micro-wire patterns configured to reduce or eliminate interference patterns.

U.S. Patent Application Publication No. 2011/0291966 discloses an array of diamond-shaped micro-wire structures. In this disclosure, a first electrode includes a plurality of first conductor lines inclined at a predetermined angle in clockwise and counterclockwise directions with respect to a first direction and provided at a predetermined interval to form a grid-shaped pattern. A second electrode includes a plurality of second conductor lines, inclined at the predetermined angle in clockwise and counterclockwise directions with respect to a second direction, the second direction perpendicular to the first direction and provided at the predetermined interval to form a grid-shaped pattern. This arrangement is used to inhibit Moiré patterns. The electrodes are used in a touch screen device.

Capacitive touch screens typically include arrays of capacitors whose capacitance is repeatedly tested to detect a touch. In order to detect touches rapidly and accurately, highly conductive electrodes are useful. In order to readily view displayed information on a display at a display location through a touch screen, it is useful to have a highly transparent touch screen that does not visibly affect any light emitted from an underlying display. There is a need, therefore, for an improved method and device for providing increased conductivity and transparency for electrodes in a capacitive touch-screen device with a display.

### SUMMARY OF THE INVENTION

In accordance with the present invention, a display device with micro-wires, comprises:

a display having an arrangement of pixels; and

substantially opaque micro-wires arranged over the pixels so that the micro-wires occlude substantially equal amounts of light from each pixel.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIGS. 1-8 are plan views of various pixel arrangements with micro-wires arranged over the pixels in various embodiments of the present invention;

FIG. 9A is an exploded perspective of a substrate with a first layer of micro-wire electrodes and a display with a pixel arrangement in an embodiment of the present invention;

FIG. 9B is an exploded perspective of a substrate with a second layer of micro-wire electrodes and a display with a pixel arrangement in the embodiment of the present invention illustrated in FIG. 7A;

FIG. 9C is a combination of the illustrations of FIGS. 7A and 7B showing an exploded perspective of a substrate with first and second layers of micro-wire electrodes and a display with a pixel arrangement in an embodiment of the present invention;

FIG. 10 is a plan view of micro-wires forming electrodes and dummy wires arranged over the pixels in an embodiment of the present invention;

FIGS. 11 and 12 are cross sections of alternative embodiments of micro-wire structures useful in the present invention; and

FIGS. 13 and 14 are flow charts illustrating various methods of the present invention.

The Figures are not drawn to scale since the variation in size of various elements in the Figures is too great to permit depiction to scale.

### DETAILED DESCRIPTION OF THE INVENTION

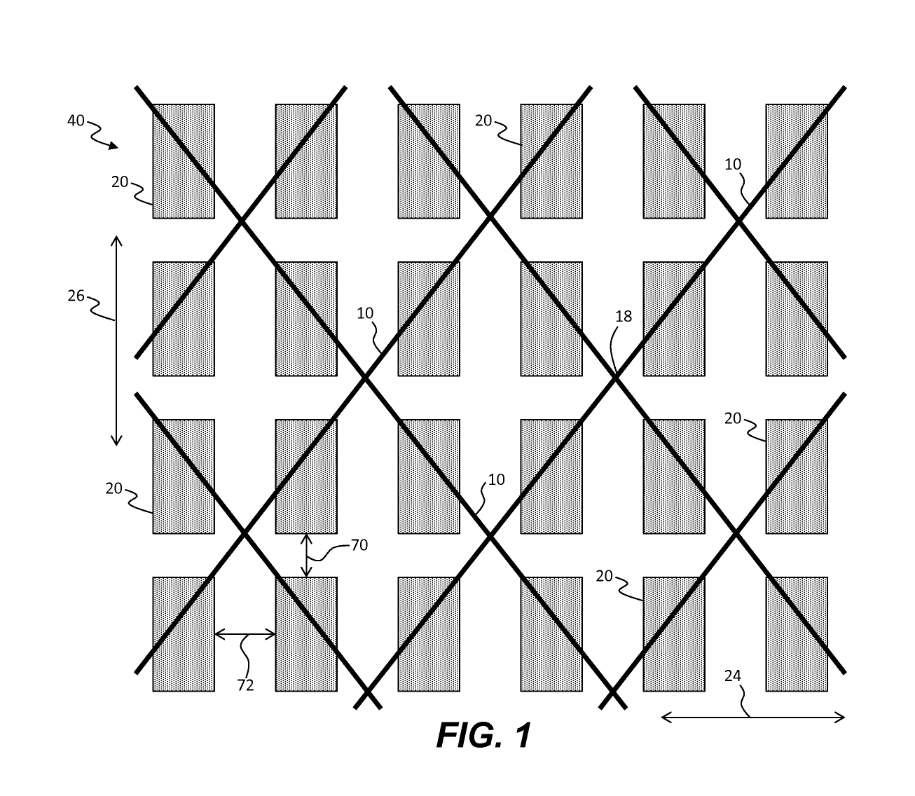

Referring to FIG. 1 in an embodiment of the present invention, a display 40 has an arrangement of spaced-apart pixels 20. Pixels 20 are arranged in rows having a row direction 24 and in columns having a column direction 26. Rows of pixels 20 are separated by row gaps 70 in column direction 26. Columns of pixels 20 are separated by column gaps 72 in row direction 24. Substantially opaque micro-wires 10 are arranged over pixels 20 so that micro-wires 10 occlude substantially equal amounts of light from each pixel 20. By occluding substantially equal amounts of light from each pixel 20 is meant that there is no perceptible visible difference of the amount of light from each pixel 20.

The pixel 20 is one or more light-controlling elements, for example in display 40. In some prior-art usages, the pixel 20 is an individual light-controlled element. In other prior-art usages, the pixel 20 includes multiple sub-pixels. Each sub-pixel controls light of a primary color. Together, the sub-pixels of the pixel 20 control light to produce a color. As used herein, the pixel 20 can also refer to a sub-pixel as a light-controlling element. The use of pixels 20 and colored sub-pixels are known in the display art.

As used herein, micro-wires 10 arranged over pixels 20 indicates that micro-wires 10 are between a viewer viewing display 40 and display 40. In various arrangements of display 40 and micro-wires 10, micro-wires 10 can be over, under, above, beneath, adjacent to in any direction, or on pixels 20, so long as the viewer perceives micro-wires 10 between the viewer and pixels 20 of display 40 so that micro-wires 10 occlude substantially equal amounts of light from each pixel 20.

In various embodiments of the present invention, light from a pixel 20 can be light emitted by the pixel 20, for example in an electroluminescent or light-emitting diode display, reflected from the pixel 20, for example in a reflective liquid crystal display, or controlled by the pixel 20, for example in a transmissive liquid crystal display. In these embodiments, pixels 20 control light at a location on display 40, as is known in the display arts; the present invention is not limited by the display type or mechanism by which pixel 20 controls light at a location in display 40.

As illustrated in FIG. 1, pixels 20 in display 40 are formed in an array having a first dimension extending in row direction 24 and a second dimension extending in column direction 26 different from row direction 24. At least some of micro-wires 10 are straight and extend in a direction that is not the same as either the row or column directions 24, 26. In the embodiment of FIG. 1, micro-wires 10 extend in a direction that is different from either row direction 24 or column direction 26, to form a diamond pattern relative to the rectilinear array arrangement of pixels 20. Micro-wires 10 form micro-wire intersections 18 between pixels 20 in either row gaps 70, or column gaps 72, or both, and do not occlude light from pixels 20. In an embodiment, a spatial translation of micro-wires 10 can result in a movement of micro-wire intersections 18 to a location over pixels 20.

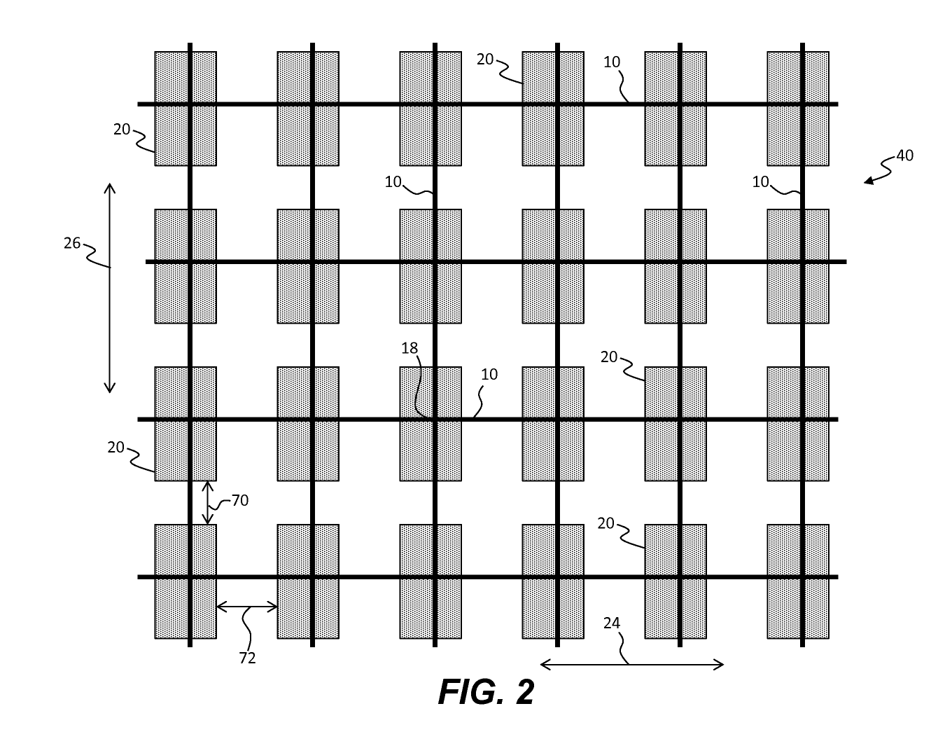

In an alternative embodiment illustrated in FIG. 2, pixels 20 in display 40 are formed in an array having a first dimension extending in row direction 24 and a second dimension extending in column direction 26 different from row direction 24. At least some of micro-wires 10 are straight and extend in a direction that is the same as either the row or column directions 24, 26. Thus, micro-wires 10 have a regular rectilinear arrangement corresponding to the arrangement of pixels 20. Micro-wires 10 form micro-wire intersections 18 over pixels 20 so that micro-wire intersections 18 occlude light from pixels 20. In an embodiment, a spatial translation of micro-wires 10 can result in a movement of micro-wire intersections 18 to a location between pixels 20.

Because identical amounts of light from each pixel 20 are occluded by micro-wires 10, there is no difference in light from each pixel 20 viewed by a viewer when pixels 20 are controlled (for example by a display controller, not shown) to emit, reflect, or transmit equal amounts of light. Therefore, variations in light output is reduced or eliminated. Thus, the present invention can provide a display 40 and a micro-wire touch screen 50 that do not exhibit color fringing, color aliasing, or variations in luminance due to micro-wires 10. Furthermore, if micro-wires 10 have a sufficiently small width when viewed from a designed display viewing distance, micro-wires 10 will not be visible to the display 40 observer at the designed display viewing distance.

Micro-wire electrodes used in touch screens of the prior art are designed without regard to the display pixel arrangements with which they are used. In contrast, embodiments of the present invention require micro-wires 10 whose arrangements that are at least partly determined by display pixel arrangements. Thus, the combination of a prior-art micro-wire touch screen with a display does not teach, motivate, or suggest a combination of a micro-wire touch screen with a display in which the display pixel layout at least partly determines the touch screen micro-wire arrangement.

In a further embodiment of the present invention and as illustrated in FIGS. 1 and 2, micro-wire intersections 18 define a straight line that extends in a direction that is the same as either the row direction 24 or column direction 26. Micro-wire intersections 18 can be more visible to the human visual system and thus more visible to a viewer, for example in part because such micro-wire intersections 18 are difficult to form without undesirable enlargement of the micro-wire intersection 18. By locating micro-wire intersections 18 at a consistent location with respect to pixels 20, color fringing, color aliasing, or luminance variations due to micro-wire intersections 18 is reduced or eliminated. By locating micro-wire intersections 18 between pixels 20, for example in row gaps 70 or column gaps 72 as shown in FIG. 1, micro-wire intersections 18 do not occlude light from pixels 20 and color fringing, color aliasing, or luminance variations due to micro-wire intersections 18 is eliminated.

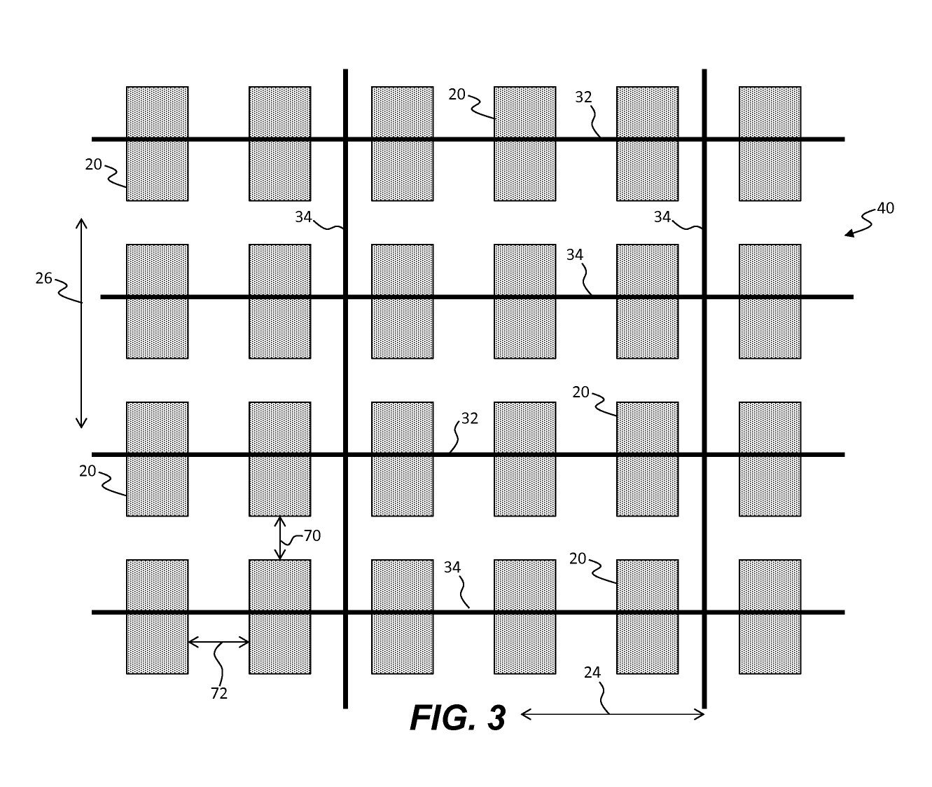

In a further embodiment of the present invention, referring to FIG. 3, first micro-wires 32 extend in a first micro-wire direction (row direction 24) and second micro-wires 34 extending in a second micro-wire direction (column direction 26) different from the first micro-wire direction. Pixels 20 are spaced-apart in at least one dimension and second micro-wires 34 are located between pixels 20. Thus, for first and second micro-wire 32, 34 arrangements in which first or second micro-wire 32, 34 are located in row or column gaps 70, 72, the total area occluded by first and second micro-wire 32, 34 is reduced, improving the light-output efficiency of pixels 20 and decreasing visibility of second micro-wires 34. In an embodiment, shown in FIG. 3, spacing between first micro-wires 32 is different from spacing between second micro-wires 34. Moreover, in yet another embodiment, the number of first micro-wires 32 is different from the number of second micro-wires 34, as is also shown in FIG. 3. The designation of micro-wires as first micro-wires 32 and second micro-wires 34 is arbitrary and the designations can be exchanged. Thus, in another embodiment, first micro-wires 32 are located between pixels 20 (not shown).

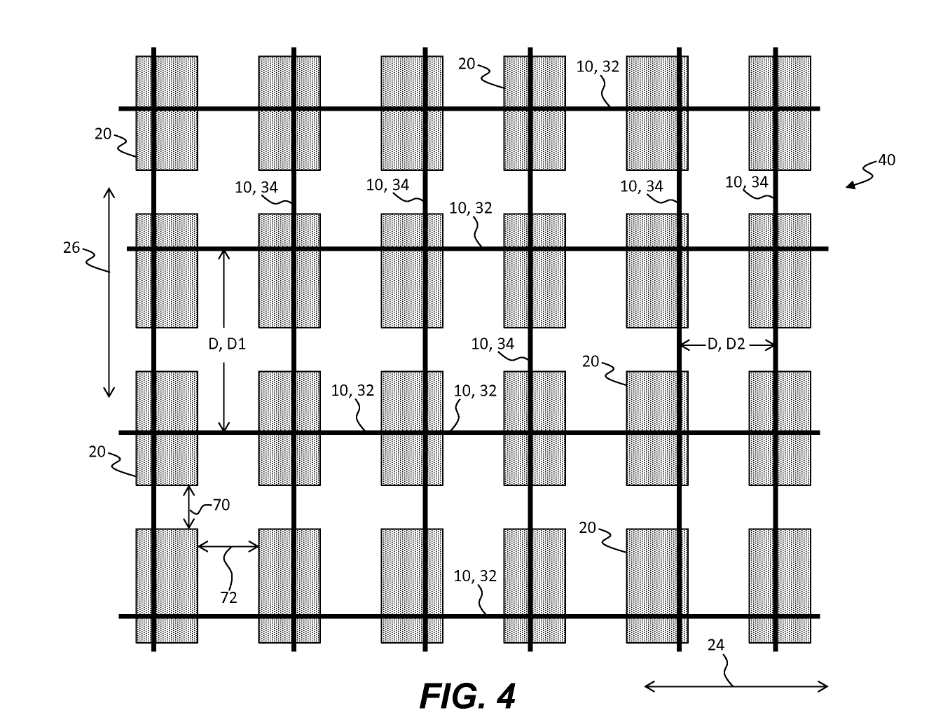

Referring to FIG. 4, in an embodiment, micro-wires 10 are spaced apart by a variable distance D. As shown in FIG. 4, micro-wires 10 extend in row direction 24 and column direction 26 and are spaced apart by a variable distance D. In yet another embodiment, as also shown in FIG. 4, first micro-wires 32 are spaced apart by a variable distance D1 and second micro-wires 34 are spaced-apart by a variable distance D2. Furthermore, the variable spacing arrangements of first micro-wires 32 in column direction 26 is different from the variable spacing arrangements of second micro-wires 34 in row direction 24, for example by having a different average spacing distance.

Although pixels 20 in display 40 are shown in a regular layout arrangement, in other embodiments, the spacing of pixels 20 is also variable. Furthermore, although pixels 20 are illustrated for clarity in a rectilinear arrangement, for example a stripe configuration, according to various embodiments of the present invention, other pixel 20 arrangements are possible, for example patterns in which one row or column is offset with respect to a neighboring row or column (not shown).

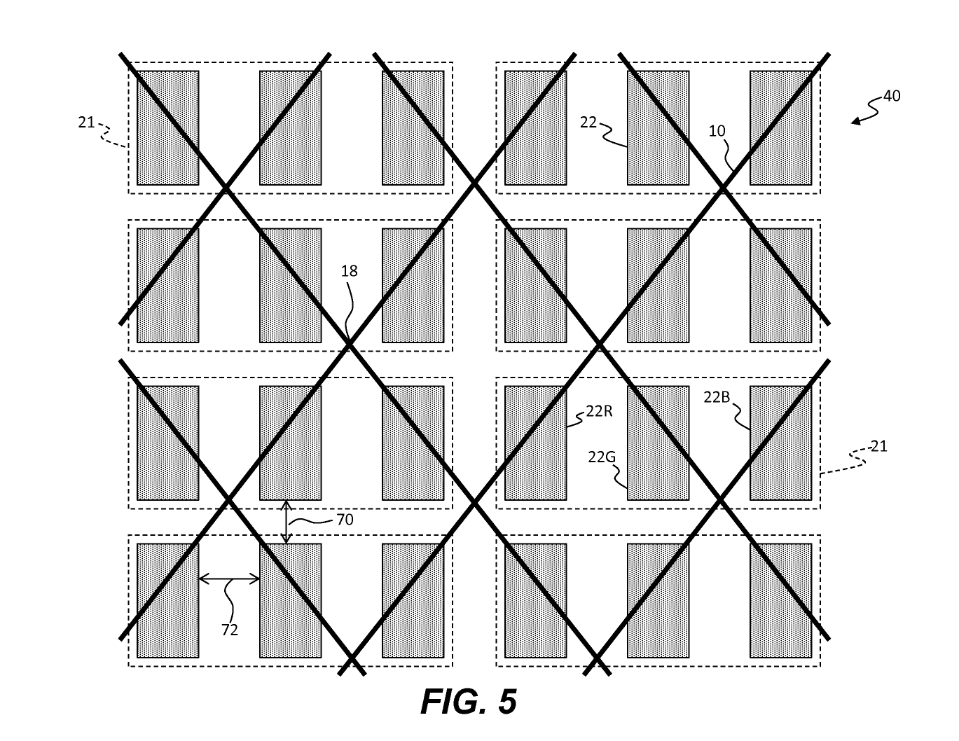

Referring to FIG. 5, in another embodiment, each pixel 20 in the display 40 is a color pixel 21 that includes two or more sub-pixels 22, each sub-pixel 22 in color pixel 21 controlling light of a color different from the color of light controlled by any other sub-pixel 22 in color pixel 21. Substantially opaque micro-wires 10 occlude substantially equal amounts of light from each color of sub-pixel 22. Sub-pixels 22 are, for example, red sub-pixels 22R, green sub-pixels 22G, or blue sub-pixels 22B. It is known in the display arts to provide pixels with red, green, and blue sub-pixels. Different colors of sub-pixels 22 can have the same size, or have different sizes. They can be spaced apart by the column gap 72 or row gaps 70 and can be arranged in rows or columns or in triangular arrangements (not shown).

Because identical amounts of light from each sub-pixel 22 are occluded by micro-wires 10, there is no difference in light from each sub-pixel 22 viewed by a viewer when sub-pixels 22 are controlled (for example by a display controller, not shown) to emit, reflect, or transmit equal amounts of light. Therefore, no color fringing, color aliasing, or luminance variations due to micro-wires 10 is possible in such displays 40.

In various embodiments of the present invention, pixel 20 arrangements and sub-pixel 22 arrangements are not distinguished. Pixels 20 in FIGS. 1-4 can also refer to sub-pixels 22. In such cases, micro-wires 10 can extend in the same directions as rows or columns of sub-pixels 22, or in different directions. Micro-wire intersections 18 are located between pixels 20 or sub-pixels 22 in row gaps 70 or column gaps 72 (as shown in FIG. 5) or are located over sub-pixels 22 (FIGS. 2 and 4). Micro-wires 10 can include first micro-wires 32 located over sub-pixels 22 and second micro-wires 34 located between sub-pixels 22 (FIG. 3). In other embodiments, micro-wires 10 are separated by variable distances in row directions 24 or column directions 26, or by other, different directions in one or two dimensions (FIG. 4). The distribution of sub-pixels 22 can be regular or can vary, even if the distribution of pixels 20 is regular. The average number of micro-wires 10 in each dimension can be different. The distribution of micro-wires 10 can be regular or can vary in one or two dimensions. The number of micro-wires 10 in each dimension can be different.

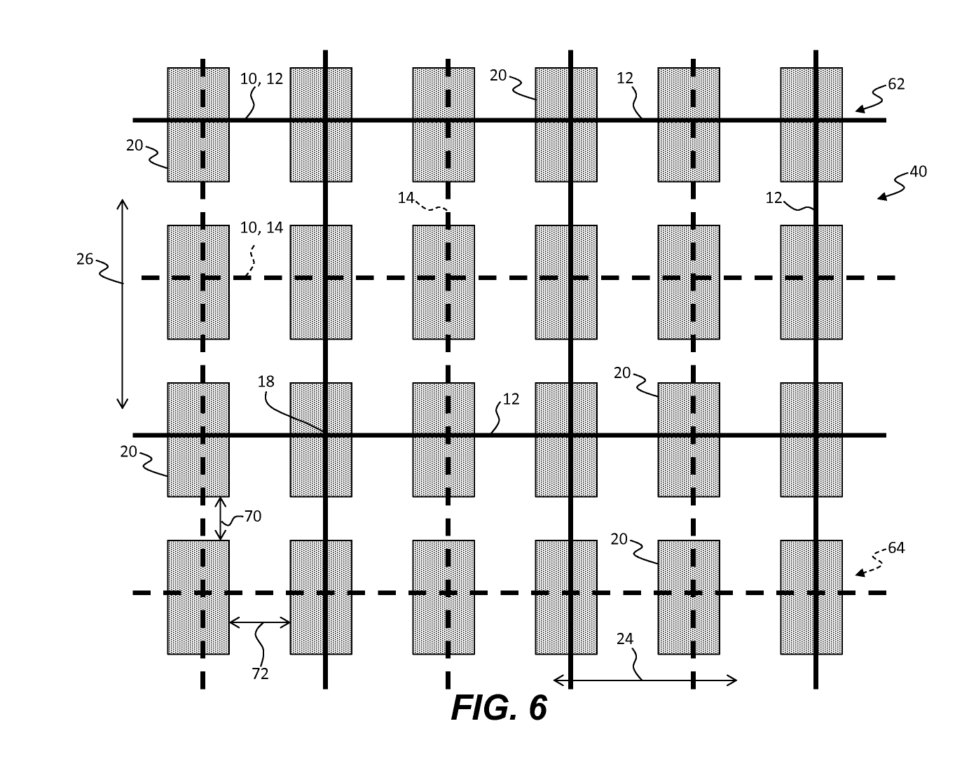

Referring to FIG. 6, in another embodiment of the present invention, the display 40 has an arrangement of pixels 20 arranged in rows having row direction 24 and columns having column direction 26. Rows of pixels 20 are separated by row gaps 70 and columns of pixels 20 are separated by column gaps 72. Micro-wires 10 include first electrode micro-wires 12 arranged to form first electrodes 62 and second electrode micro-wires 14 arranged to form second electrodes 64. First electrodes 62 and second electrodes 64 are electrically isolated. Opaque first electrode micro-wires 12 and second electrode micro-wires 14 are arranged over pixels 20 so that first and second electrode micro-wires 12, 14 occlude substantially equal amounts of light from each pixel 20. First and second electrodes 62, 64 including first and second electrode micro-wires 12, 14 can form a touch screen. First and second electrodes 62, 64 can extend in different, for example orthogonal, directions, such as row direction 24 and column direction 26 and overlap to form capacitors whose capacitance can be tested by electronic circuits electrically connected to first and second electrodes 62, 64 to detect touches.

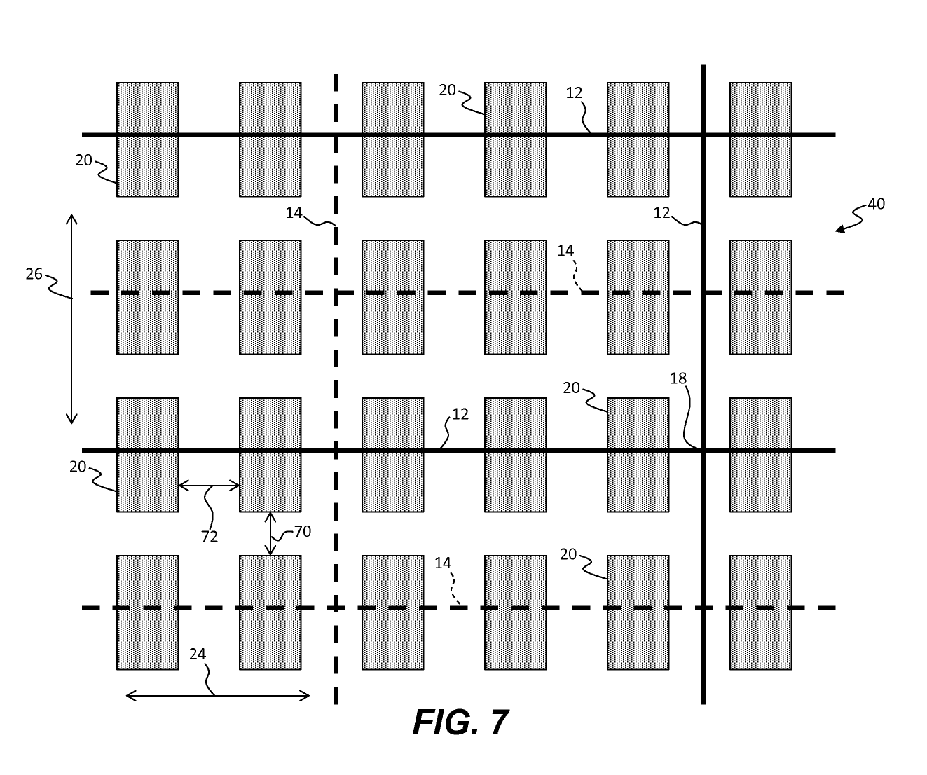

In the embodiment illustrated in FIG. 6, first and second electrode micro-wires 12, 14 are located over pixels 20 in display 40 and micro-wire intersections 18 are also located over pixels 20. Referring to FIG. 7, only some of first and second electrode micro-wires 12, 14 are located over pixels 20 in display 40. Other first and second electrode micro-wires 12, 14 are located between pixels 20 in row gaps 70 or column gaps 72. Micro-wire intersections 18 are also located between pixels 20 in row gaps 70 or column gaps 72. Micro-wire intersections 18 can be formed from intersecting first electrode micro-wires 12, intersecting second electrode micro-wires 14, or visible apparent intersections between first electrode micro-wires 12 and second electrode micro-wires 14.

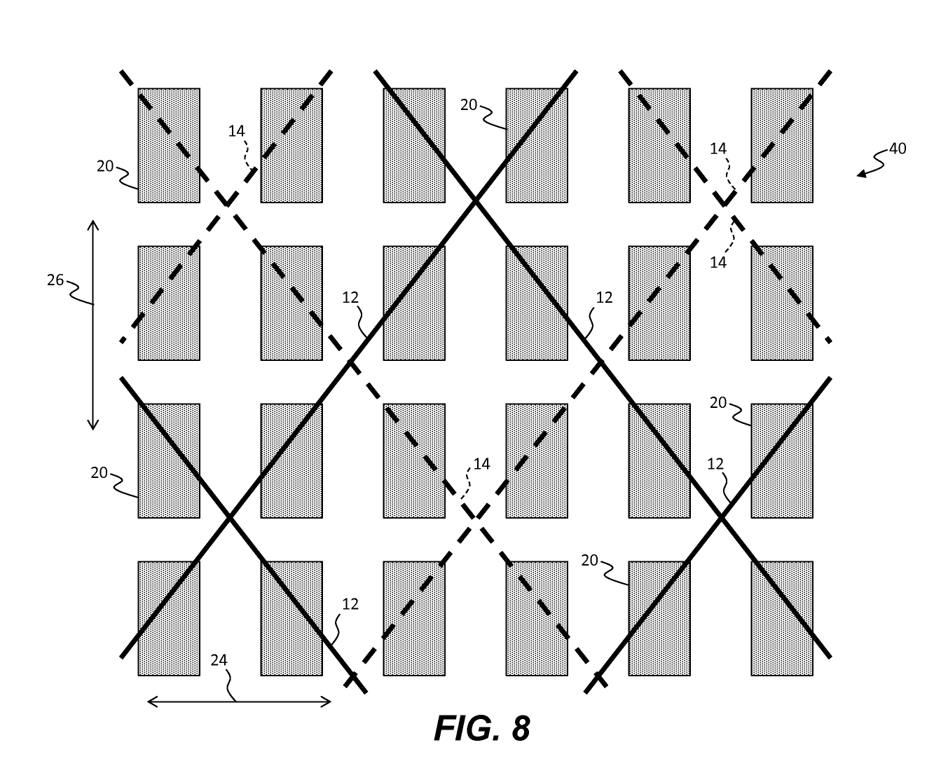

FIGS. 6 and 7 illustrate first and second electrode micro-wires 12, 14 extending in row and column directions 24, 26. In another embodiment illustrated in FIG. 8, first and second electrode micro-wires 12, 14 located partially over pixels 20 in display 40 extend in directions different from row or column directions 24, 26. Such an arrangement can help to reduce the visibility of first and second electrode micro-wires 12, 14.

In an embodiment, first electrode micro-wires 12 in the first electrode 62 form an electrically interconnected mesh. Likewise, second electrode micro-wires 14 in the second electrode 64 form an electrically interconnected mesh. As illustrated in FIGS. 6-8, first electrode micro-wires 12 are spatially out of phase with second electrode micro-wires 14 by 180 degrees.

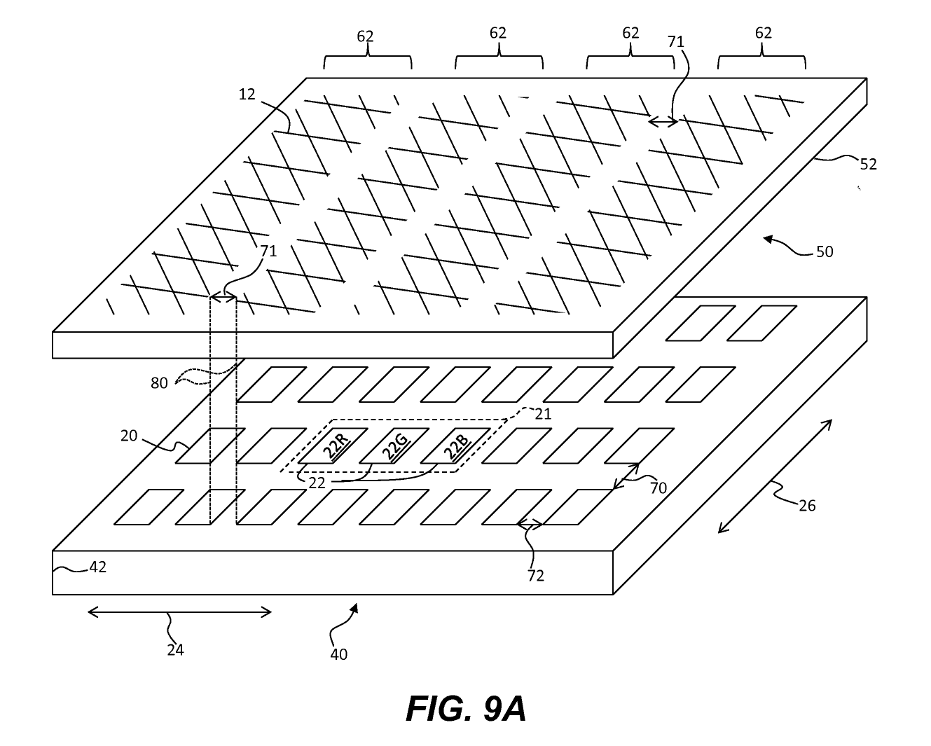

FIGS. 9A, 9B, and 9C all refer to the embodiment illustrated in FIG. 9C. FIGS. 9A and 9B are provided for clarity in understanding. FIG. 9A shows only first electrode micro-wires 12 and FIG. 9B shows only second electrode micro-wires 14. Referring to FIGS. 9A, 9B, and 9C, the display 40 has a display substrate 42 on, in, or over which pixels 20 are arranged. Pixels 20 can be arranged in color pixels 21 having two or more color sub-pixels, for example, red, green, and blue sub-pixels 22R, 22G, and 22B. The touch screen 50 includes a touch screen substrate 52 on, above, or below which are arrays of first and second electrodes 62, 64. Touch screen substrate 52 can be a dielectric layer.

First and second electrodes 62, 64 each include first and second electrode micro-wires 12, 14, respectively. First electrodes 62 extend in a direction orthogonal to second electrodes 64. For example first electrodes 62 extend in column direction 26 and second electrodes 64 extend in row direction 24. First electrodes 62 are separated by a first electrode gap 71 and are made of first electrode micro-wires 12. Second electrodes 64 are separated by a second electrode gap 73 and are made of second electrode micro-wires 14. The first and second electrode micro-wires 12, 14 of each of first or second electrodes 62, 64, respectively, forms an electrically connected mesh of micro-wires 10. Each of first or second electrodes 62, 64 is electrically isolated from others of the first or second electrodes 62, 64.

Referring specifically to FIG. 9A, first electrode gaps 71 between first electrodes 62 are located within column gaps 72, as indicated by projection lines 80. First electrode micro-wires 12 of first electrodes 62 are located over more than one row of pixels 20 or more than one column of pixels 20. As shown in FIG. 9A, first electrode micro-wires 12 of first electrodes 62 are located over two columns of pixels 20. Referring specifically to FIG. 9B, second electrode gaps 73 between second electrodes 64 are located within row gaps 70, as indicated by projection lines 80. Second electrode micro-wires 14 of second electrodes 64 are located over more than one row of pixels 20 or over more than one column of pixels 20. As shown in FIG. 9B, second electrode micro-wires 14 of second electrodes 64 are located over two rows of pixels 20.

As shown in FIG. 9C, first electrode micro-wires 12 of first electrode 62 are substantially 180 degrees spatially out of phase with second electrode micro-wires 14 of second electrode 64.

As noted with respect to FIGS. 9A, 9B, and 9C, pixels 20 can be color pixels 21 and include different sub-pixels that control light of different colors (such as red, green, and blue sub-pixels 22R, 22G, and 22B). Therefore, in an embodiment of the present invention, a display apparatus with micro-wires can include the display 40 having an arrangement of color pixels 21, each color pixel 21 including two or more sub-pixels 22, each sub-pixel 22 in color pixel 21 controlling light of a color different from the color of light controlled by any other sub-pixel 22 in color pixel 21. Touch screen 50 includes substantially opaque micro-wires 10 arranged over sub-pixels 22 so that micro-wires 10 occlude substantially equal amounts of light from each sub-pixel 22. By occluding substantially equal amounts of light from each sub-pixel 22 is meant that there is no perceptible visible difference of the amount of light from each sub-pixel 22.

In the Figures, the pixel 20 is also considered to be the sub-pixel 22 so that pixels 20 and sub-pixels 22 are not necessarily distinguished. Thus, in another embodiment, first electrode micro-wires 12 of first electrodes 62 are located over more than one row of sub-pixels 22 or more than one column of sub-pixels 22. As shown in FIG. 9A, first electrode micro-wires 12 of first electrodes 62 are located over two columns of sub-pixels 22. Second electrode micro-wires 14 of second electrodes 64 are located over more than one row of sub-pixels 22 or over more than one column of sub-pixels 22. As shown in FIG. 9B, second electrode micro-wires 14 of second electrodes 64 are located over two rows of sub-pixels 22.

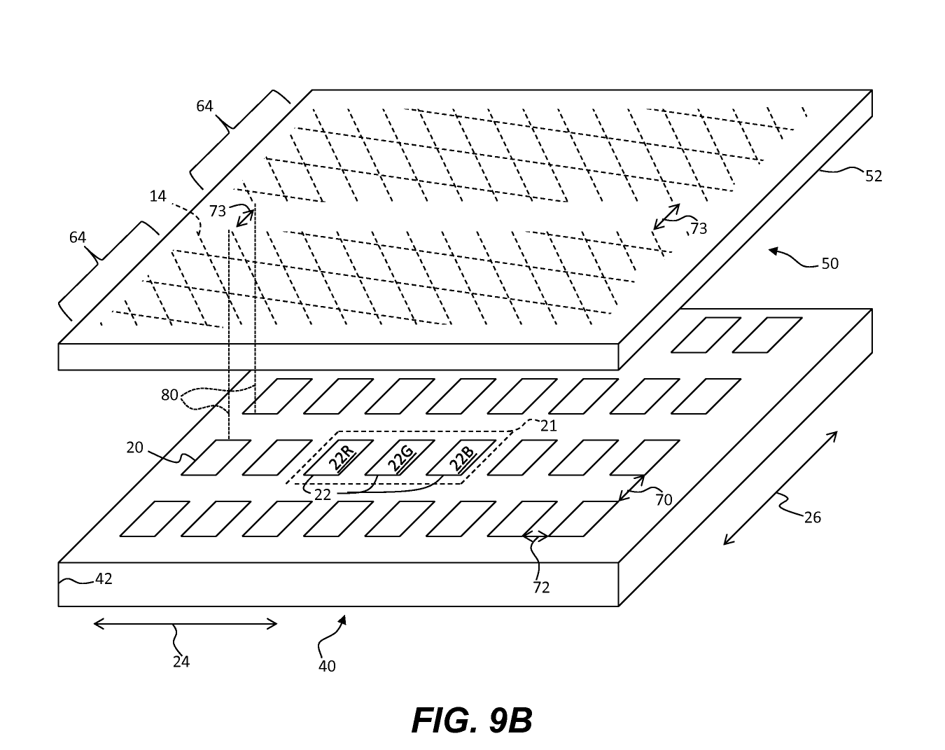

Referring to FIG. 10, according to another embodiment of the present invention, at least some of micro-wires 10 are arranged to form one or more dummy electrodes 66 located between two first electrodes 62 and electrically isolated from first electrodes 62. Micro-wires 10 of dummy electrodes 66 and micro-wires 10 of first electrodes 62 occlude substantially equal amounts of light from each sub-pixel 22 or from each pixel 20.

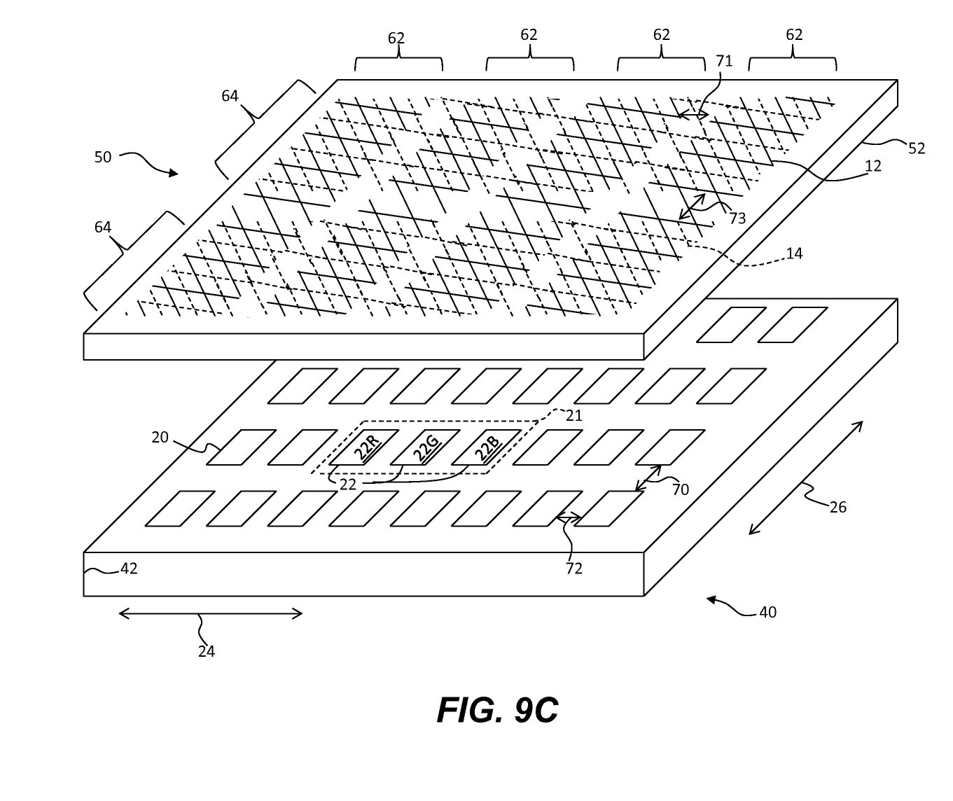

Referring to FIG. 11, first and second electrode micro-wires 12 of first electrode 62 are formed in a separate plane from second electrode micro-wires 14 of second electrode 64. As shown in FIG. 11, first electrode micro-wires 12 forming first electrode 62 of touch screen 50 are formed on a first side 54 of touch screen substrate 52. Second electrode micro-wires 14 forming second electrode 64 of touch screen 50 are formed on an opposing second side 56 of touch screen substrate 52.

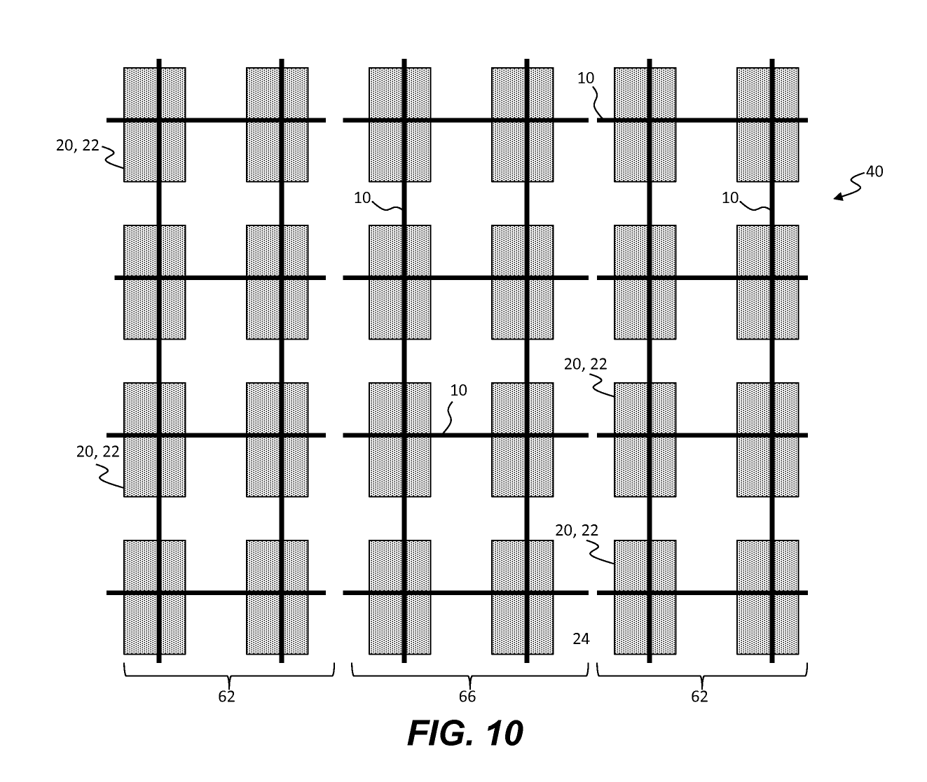

Alternatively, as shown in FIG. 12, first electrode micro-wires 12 of first electrode 62 are formed in a common plane with second electrode micro-wires 14 of second electrode 64. As shown in FIG. 12, first electrode micro-wires 12 forming first electrode 62 of touch screen 50 are formed on first side 54 of touch screen substrate 52. Second electrode micro-wires 14 forming second electrode 64 of touch screen 50 are also formed on first side 54 of touch screen substrate 52 opposite second side 56 of touch screen substrate 52. When first electrodes 62 extend in a different direction from second electrodes 64, second electrode micro-wires 14 pass under first electrode micro-wires 12 with micro-wire vias 16.

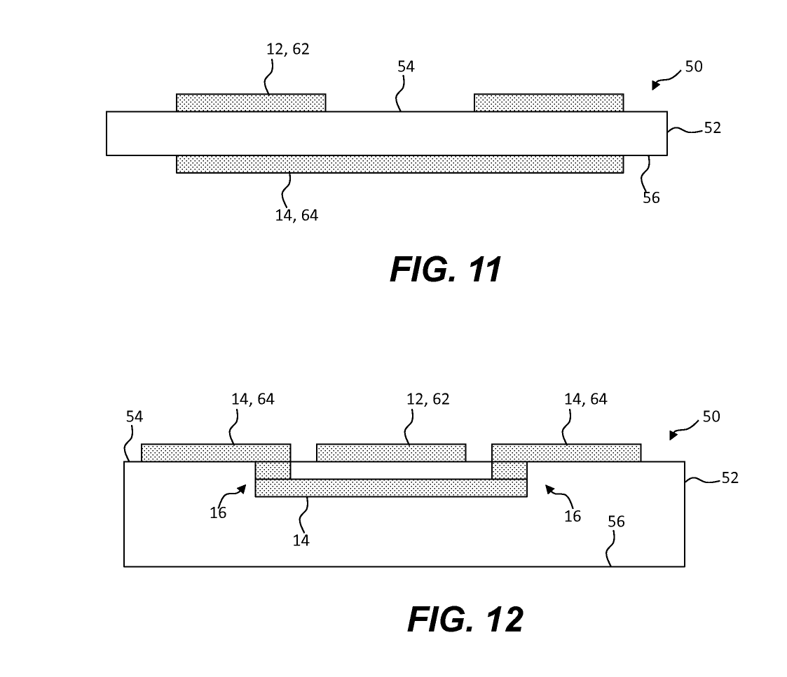

Referring to FIG. 13, in an embodiment of the present invention, a method of making a display apparatus with micro-wires 10 includes providing in step 100 an arrangement of pixels 20 for the display 40. Substantially opaque micro-wires are arranged over pixels 20 in step 105 so that micro-wires 10 occlude substantially equal amounts of light from each pixel 20. Alternatively, each pixel 20 is a color pixel 21 that includes two or more sub-pixels 22, each sub-pixel 22 in color pixel 21 controlling light of a color different from the color of light controlled by any other sub-pixel 22 in color pixel 21. Substantially opaque micro-wires are arranged over sub-pixels 22 so that micro-wires 10 occlude substantially equal amounts of light from each sub-pixel 22.

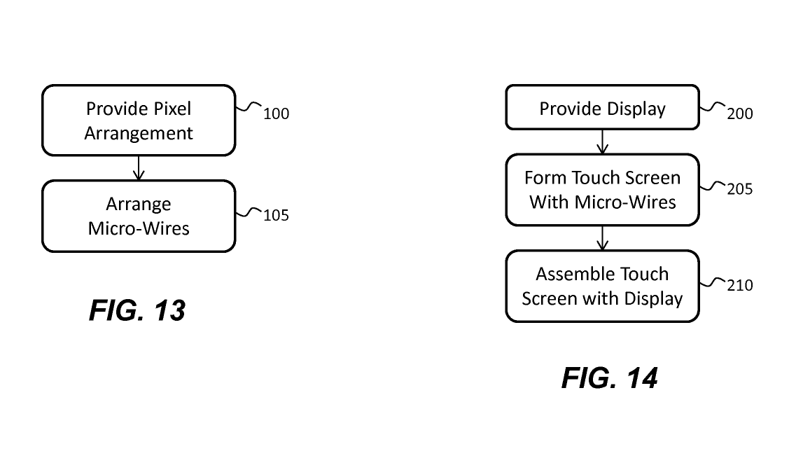

In an embodiment, micro-wires 10 of the present invention are part of touch screen 50 and pixels 20 or color pixels 21 are part of display 40. Thus, in such an embodiment, referring to FIG. 14, display 40 is provided in step 200, touch screen 50 with micro-wires 10 is formed in step 205, and display 40 is assembled in step 210 with touch screen 50. In other embodiments, touch screen 50 is an element of display 40, for example display substrate 42 or a display cover. Touch screen substrate 52, for example, can be display substrate 42 or a display cover. In this embodiment, touch screen 50 is assembled in step 210 as part of display 40.

Embodiments of the present invention are made by forming micro-wires on, over, or beneath a touch screen substrate 52 as described above and illustrated in the Figures. Likewise, pixels 20, color pixels 21, or sub-pixels 22 are formed on, over, or beneath the display substrate 42 as described above and illustrated in the Figures. A display-and-touch-screen apparatus of the present invention having micro-wires 10 and pixels 20 is operated using display controller and touch screen controllers known in the art. Materials, methods, and processes for making displays, for example liquid crystal displays or light-emitting diode displays are practiced in the display industry. Materials, methods, and processes for making micro-wires in patterns useful for touch screens 50 are also known in the art, for example using photolithographic technologies. Touch screen 50 can be a capacitive touch screen.

Pixels 20 of display 40 can be electrically controlled with electrical signals by a display controller (not shown). Similarly, first and second electrodes 62, 64 can be electrically controlled by an electrode control circuit (not shown). Such circuits can be analog or digital, formed in integrated or discrete circuits and can include processors, logic arrays, programmable logic arrays, memories, and lookup tables and are well known. The design, layout, and control of pixels 20 over display substrates 42 are commonplace in the display industry.

As will be readily understood by those familiar with the lithographic and display design arts, the terms row and column are arbitrary designations of two different, usually orthogonal, dimensions in a two-dimensional arrangement of pixels 20 or first and second electrodes 62, 64 on a surface, for example a substrate surface, and can be exchanged. That is, a row can be considered as a column and a column considered as a row simply by rotating the surface ninety degrees with respect to a viewer. Hence, first electrode 62 can be interchanged with second electrode 64. Similarly, the designations of rows and columns of pixels and row and column gaps 70, 72 can be interchanged.

Touch screen controllers for capacitive touch screens (e.g. touch screen 50) provide a voltage differential sequentially to first and second electrodes 62, 64 to scan the capacitance of the capacitor array formed where first and second electrodes 62, 64 overlap. Any change in the capacitance of a capacitor in the array can indicate a touch at the location of the capacitor in the array. The location of the touch can be related to information presented on one or more pixels 20 at the corresponding pixel location to indicate an action or interest in the information presented by a display controller at the corresponding pixel location.

Substrates of the present invention can include any material capable of providing a supporting surface on which first and second electrodes 62, 64, micro-wires 10, or pixels 20 can be formed and patterned. Substrates such as glass, metal, or plastics can be used and are known in the art together with methods for providing suitable surfaces on the substrates. In a useful embodiment, substrates are substantially transparent, for example having a transparency of greater than 90%, 80% 70% or 50% in the visible range of electromagnetic radiation.

Various substrates of the present invention can be similar substrates, for example made of similar materials and having similar material deposited and patterned thereon. Likewise, first and second electrodes 62, 64 of the present invention can be similar, for example made of similar materials using similar processes.

Micro-wires 10 of the present invention can be formed directly on substrates or over substrates (e.g. touch screen substrate 52) or on layers formed on substrates. The words “on”, “over’, or the phrase “on or over” indicate that micro-wires 10 of the present invention can be formed directly on a substrate, on layers formed on a substrate, or on other layers or another substrate located so that micro-wires 10 are over the desired substrate. “Over” or “under”, as used in the present disclosure, are simply relative terms for layers located on or adjacent to opposing surfaces of a substrate. By flipping the substrate and related structures over, layers that are over the substrate become under the substrate and layers that are under the substrate become over the substrate. The descriptive use of “over” or “under” do not limit the structures of the present invention.

Micro-wires 10 are formed in a micro-wire layer that forms a conductive mesh of electrically connected micro-wires within first or second electrode 62, 64. If touch screen substrate 52 is planar, for example a rigid planar substrate such as a glass substrate, micro-wires 10 in a micro-wire layer are formed in, or on, a common plane as a conductive, electrically connected mesh. If touch screen substrate 52 is flexible and curved, for example a plastic substrate, micro-wires 10 in a micro-wire layer are a conductive, electrically connected mesh that is a common distance from a surface of touch screen substrate 52 within first or second electrode 62, 64. Micro-wires 10 can be formed on touch screen substrate 52 or on a layer above (or beneath) touch screen substrate 52.

In an example and non-limiting embodiment of the present invention, each micro-wire 10 is 5 microns wide and separated from neighboring micro-wires 10 in first or second electrodes 62, 64 by a distance of 50 microns or more, so that the transparent electrode is 90% transparent or more. As used herein, transparent refers to elements that transmit at least 50% of incident visible light, preferably 80% or at least 90%. Micro-wires 10 can be arranged in a micro-pattern that is unrelated to the pattern of first or second electrodes 62, 64. Micro-patterns other than those illustrated in the Figures can be used in other embodiments and the present invention is not limited by the pattern of first or second electrodes 62, 64 or the pattern of micro-wires 10. To achieve transparency, the total area occupied by micro-wires 10 can be less than 15% of the first or second electrode 62, 64 area.

Coating methods for making dielectric layers or protective layers are known in the art and can use, for example, spin or slot coating or extrusion of plastic materials on a substrate, or sputtering. Suitable materials are also well known. The formation of patterned electrical wires or micro-wires 10 on a substrate are also known, as are methods of making displays, such as OLED or liquid crystal, on a substrate and providing and assembling display covers with display substrates 42.

Micro-wires 10 can be metal, for example silver, gold, aluminum, nickel, tungsten, titanium, tin, or copper or various metal alloys including, for example silver, gold, aluminum, nickel, tungsten, titanium, tin, or copper. Other conductive metals or materials can be used. Micro-wires 10 can be made of a thin metal layer. Alternatively, micro-wires 10 can include cured or sintered metal particles such as nickel, tungsten, silver, gold, titanium, or tin or alloys such as nickel, tungsten, silver, gold, titanium, or tin. Conductive inks can be used to form micro-wires 10 with pattern-wise deposition and curing steps. Other materials or methods for forming micro-wires 10 can be employed and are included in the present invention.

Micro-wires 10 can be formed by patterned deposition of conductive materials or of patterned precursor materials that are subsequently processed, if necessary, to form a conductive material. Suitable methods and materials are known in the art, for example inkjet deposition or screen printing with conductive inks. Alternatively, micro-wires 10 can be formed by providing a blanket deposition of a conductive or precursor material and patterning and curing, if necessary, the deposited material to form a micro-pattern of micro-wires 10. Photo-lithographic and photographic methods are known to perform such processing. The present invention is not limited by the micro-wire materials or by methods of forming a pattern of micro-wires 10 on a supporting substrate surface. Commonly-assigned U.S. Ser. No. 13/406,649 filed Feb. 28, 2012, the disclosure of which is incorporated herein, discloses a variety of materials and methods for forming patterned micro-wires on a substrate surface.

In embodiments of the present invention, micro-wires 10 are made by depositing an unpatterned layer of material and then differentially exposing the layer to form the different micro-wire 10 micro-patterns. For example, a layer of curable precursor material is coated over the substrate and pattern-wise exposed. The first and second micro-patterns are exposed in a common step or in different steps. A variety of processing methods can be used, for example photo-lithographic or silver halide methods. The materials can be differentially pattern-wise exposed and then processed.

A variety of materials can be employed to form patterned micro-wires 10, including resins that can be cured by cross-linking wave-length-sensitive polymeric binders and silver halide materials that are exposed to light. Processing can include both washing out residual uncured materials and curing or exposure steps.

In an embodiment, a precursor layer includes conductive ink, conductive particles, or metal ink. The exposed portions of the precursor layer can be cured to form micro-wires 10 (for example by exposure to patterned laser light to cross-link a curable resin) and the uncured portions removed. Alternatively, unexposed portions of micro-wire layers can be cured to form micro-wires 10 and the cured portions removed.

In another embodiment of the present invention, the precursor layers are silver salt layers. The silver salt can be any material that is capable of providing a latent image (that is, a germ or nucleus of metal in each exposed grain of metal salt) according to a desired pattern upon photo-exposure. The latent image can then be developed into a metal image. For example, the silver salt can be a photosensitive silver salt such as a silver halide or mixture of silver halides. The silver halide can be, for example, silver chloride, silver bromide, silver chlorobromide, or silver bromoiodide.

According to some embodiments, the useful silver salt is a silver halide (AgX) that is sensitized to any suitable wavelength of exposing radiation. Organic sensitizing dyes can be used to sensitize the silver salt to visible or IR radiation, but it can be advantageous to sensitize the silver salt in the UV portion of the electromagnetic spectrum without using sensitizing dyes.

Processing of AgX materials to form conductive traces typically involves at least developing exposed AgX and fixing (removing) unexposed AgX. Other steps can be employed to enhance conductivity, such as thermal treatments, electroless plating, physical development and various conductivity-enhancing baths, as described in U.S. Pat. No. 3,223,525.

In an embodiment, precursor material layers can each include a metallic particulate material or a metallic precursor material, and a photosensitive binder material.

In any of these cases, the precursor material is conductive after it is cured and any needed processing completed. Before patterning or before curing, the precursor material is not necessarily electrically conductive. As used herein, precursor material is material that is electrically conductive after any final processing is completed and the precursor material is not necessarily conductive at any other point in the micro-wire formation process.

Methods and devices for forming and providing substrates, coating substrates, patterning coated substrates, or pattern-wise depositing materials on a substrate are known in the photo-lithographic arts. Likewise, tools for laying out electrodes, conductive traces, and connectors are known in the electronics industry as are methods for manufacturing such electronic system elements. Hardware controllers for controlling touch screens and displays and software for managing display and touch screen systems are all well known. All of these tools and methods can be usefully employed to design, implement, construct, and operate the present invention. Methods, tools, and devices for operating capacitive touch screens can be used with the present invention.

Although the present invention has been described with emphasis on capacitive touch screen embodiments, the micro-wires 10 and first and second electrode 62, 64 are useful in a wide variety of electronic devices having pixels. Such devices can include, for example, photovoltaic devices, OLED displays and lighting, LCD displays, plasma displays, inorganic LED displays and lighting, electrophoretic displays, electrowetting displays, dimming mirrors, smart windows, transparent radio antennae, transparent heaters and other touch screen devices such as resistive touch screen devices.

The invention has been described in detail with particular reference to certain embodiments thereof, but it will be understood that variations and modifications can be effected within the spirit and scope of the invention.

### PARTS LIST

D, D1, D2 distance
10 micro-wire
12 first electrode micro-wire
14 second electrode micro-wire
16 micro-wire via
18 micro-wire intersection
20 pixel
21 color pixel
22 sub-pixel
22R red sub-pixel
22G green sub-pixel
22B blue sub-pixel
24 row direction
26 column direction
32 first micro-wire
34 second micro-wire
40 display
42 display substrate
50 touch screen
52 touch screen substrate
54 first side
56 second side
62 first electrode
64 second electrode
66 dummy electrode
70 row gap
71 first electrode gap
72 column gap
73 second electrode gap
80 projection line
100 provide pixel arrangement step
105 arrange micro-wires step
200 provide display step
205 form touch-screen with micro-wires step
210 assemble touch-screen with display step

1. A display device with micro-wires, comprising:
a display having an arrangement of pixels; and
substantially opaque micro-wires arranged over the pixels so that the micro-wires occlude substantially equal amounts of light from each pixel.

2. The display device of claim 1, wherein each pixel includes two or more sub-pixels, each sub-pixel in the pixel controlling light of a color different from the color of light controlled by any other sub-pixel in the pixel, and wherein the substantially opaque micro-wires occlude substantially equal amounts of light from each color of sub-pixel.

3. The display device of claim 1, wherein the pixels are formed in an array having a first dimension extending in a row direction and a second dimension extending in a column direction different from the row direction and wherein at least some of the micro-wires are straight and extend in a direction that is the same as either the first or column directions.

4. The display device of claim 1, wherein the pixels are formed in an array having a first dimension extending in a row direction and a second dimension extending in a column direction different from the row direction and wherein at least some of the micro-wires are straight and extend in a direction that is not the same as either the row or column directions.

5. The display device of claim 1, wherein the pixels are formed in an array having a first dimension extending in a row direction and a second dimension extending in a column direction different from the row direction and wherein at least some of the micro-wires intersect and the intersections define a straight line that extends in a direction that is the same as either the row direction or column direction.

6. The display device of claim 1, wherein the pixels are formed in an array having a first dimension extending in a row direction and a second dimension extending in a column direction different from the row direction, the pixels are spaced apart in at least one dimension, and wherein at least some of the micro-wires intersect and the intersections are located between the pixels.

7. The display device of claim 1, further including first micro-wires extending in a first micro-wire direction, second spaced-apart micro-wires extending in a second micro-wire direction different from the first micro-wire direction; and
wherein the pixels are spaced-apart in at least one dimension and wherein the second micro-wires are located between the pixels.

8. The display device of claim 1, wherein the micro-wires are spaced apart by a variable distance.

9. The display device of claim 1, further including first spaced-apart micro-wires extending in a first micro-wire direction, second spaced-apart micro-wires extending in a second micro-wire direction different from the first micro-wire direction, and wherein the first micro-wires are spaced apart by a variable distance and the second micro-wires are spaced-apart by a variable distance.

10. The display device of claim 8, wherein the average distance spacing apart the first micro-wires is different from the average distance spacing apart the second micro-wires, or wherein the number of first micro-wires is different from the number of second micro-wires.

11. A display device with micro-wires, comprising:
a display having an arrangement of pixels, each pixel including two or more sub-pixels, each sub-pixel in the pixel controlling light of a color different from the color of light controlled by any other sub-pixel in the pixel; and
substantially opaque micro-wires arranged over the sub-pixels so that the micro-wires occlude substantially equal amounts of light from each sub-pixel.

12. The display device of claim 11, wherein the micro-wires occlude substantially equal amounts of light from each pixel.

13. The display device of claim 11, wherein the sub-pixels are formed in an array having a first dimension extending in a row direction and a second dimension extending in a column direction different from the row direction and wherein at least some of the micro-wires are straight and extend in a direction that is the same as either the row direction or the column direction.

14. The display device of claim 11, wherein the sub-pixels are formed in an array having a first dimension extending in a row direction and a second dimension extending in a column direction different from the row direction and wherein at least some of the micro-wires are straight and extend in a direction that is not the same as either the row direction or the column direction.

15. The display device of claim 11, wherein the sub-pixels are formed in an array having a first dimension extending in a row direction and a second dimension extending in a column direction different from the row direction and wherein at least some of the micro-wires intersect and the intersections define a straight line that extends in a direction that is the same as either the row direction or column direction.

16. The display device of claim 11, wherein the sub-pixels are formed in an array having a first dimension extending in a row direction and a second dimension extending in a column direction different from the row direction, the sub-pixels are spaced apart in at least one dimension, and wherein at least some of the micro-wires intersect and the intersections are located between the sub-pixels.

17. The display device of claim 11, further including first micro-wires extending in a first micro-wire direction, second spaced-apart micro-wires extending in a second micro-wire direction different from the first micro-wire direction; and
wherein the pixels are spaced-apart in at least one dimension and wherein the first micro-wires are located between the pixels.

18. The display device of claim 11, wherein the micro-wires are spaced apart by a variable distance.

19. The display device of claim 11, further including first spaced-apart micro-wires extending in a first micro-wire direction, second spaced-apart micro-wires extending in a second micro-wire direction different from the first micro-wire direction, and wherein the first micro-wires are spaced apart by variable distance and the second micro-wires are spaced-apart by a variable distance.

20. The display device of claim 19, wherein the average distance spacing apart the first micro-wires is different from the average distance spacing apart the second micro-wires or wherein the number of first micro-wires is different from the number of second micro-wires.
